(19) United States
(12) Patent Application Publication
(10) Pub. No.: US 2007/0210181 A1
(43) Pub. Date: Sep. 13, 2007

(54) SINK SPRAY HEAD WITH SUPPLY JET VARIATION AND FLOW RATE REGULATION

(76) Inventor: Fabrizio Nobili, San Vittore (CH)

Correspondence Address: SEED INTELLECTUAL PROPERTY LAW GROUP PLLC, 701 FIFTH AVE, SUITE 5400, SEATTLE, WA, 98104, US

(21) Appl. No.: 11/680,448

(22) Filed: Feb. 28, 2007

(30) Foreign Application Priority Data
Feb. 28, 2006 (IT) MI2006A000358

(51) Int. Cl. A01G 27/00

(52) U.S. Cl. 239/68; 239/569; 239/525

(57) ABSTRACT

Sink spray head with supply jet variation and flow rate regulation, comprising a body defining at least two distinct water supply areas in communication with a distribution chamber controlled by a diverting cut-off driven by means of two distinct selection keys accessible outside the body, a cut-off being also provided for the regulation of the water flow rate. The keys are operatively connected to the regulation cut-off.

### BACKGROUND OF THE INVENTION

1. Field of the Invention

The present invention relates to a sink spray head with supply jet variation and flow rate regulation.

2. Description of the Related Art

As it is known, at present, sink spray heads on sale can be both of the “pulldown” type, i.e. associated with the tap pipe, or of the “pullout” type, i.e., withdrawable from the sink, and are structured in such a way as to execute the supply jet variation.

These spray heads are typically provided with two flanked keys which can be selectively activated so as to obtain an aerated central jet or, possibly, an indiscriminate peripheral jet.

These spray heads are also provided with a further key or button which gives the possibility to regulate the water flow rate until the supply is stopped.

There is a need for these types of spray heads to be provided with three distinct activation elements with both constructive and activation complexity, since if the flow rate regulation is to be executed then action is to be taken onto a key, which is different from the one that has allowed the choice of the supply jet type.

Moreover, when the closure of the water flow is executed by means of the flow rate regulation key, the spray head is inevitably positioned with the water supply in the central position, i.e., with aerated jet.

An aim of the present invention is that of realizing a sink spray head with supply jet variation and flow rate regulation, which gives the possibility to make the use of the spray head particularly simple, moreover conferring the possibility to simplify the use of the spray head.

A particular aim of the invention is that of realizing a spray head wherein the flow rate regulation executed directly by the spray head does not imply a variation of the supply jet type.

Another aim of the present invention is that of realizing a spray head which, thanks to its peculiar realization characteristics, is able to give the widest guarantees of reliability and safety of use.

Another aim of the present invention is that of realizing a spray head which can be easily obtained starting from elements and materials being commonly available on sale and which, moreover, is competitive from a merely economic point of view.

### BRIEF SUMMARY OF THE INVENTION

According to the present invention, the aims cited above are realized by a sink spray head with supply jet variation and flow rate regulation, comprising a body defining at least two distinct water supply areas communicating with a distribution chamber controlled by a diverting cut-off driven by two distinct selection keys accessible outside the body, a water flow rate regulation cut-off being also provided, characterized by the fact that the selection keys are operatively connected to the water flow rate regulation cut-off.

Further characteristics and advantages of the spray head according to the present invention will be better apparent from the description of a preferred, but non exclusive, embodiment of a sink spray head with supply jet variation and flow rate regulation, shown by way of indicative and non limiting example with the help of the annexed drawings.

### BRIEF DESCRIPTION OF THE SEVERAL VIEWS OF THE DRAWINGS

FIG. 1 schematically shows a possible embodiment of the sink spray head;

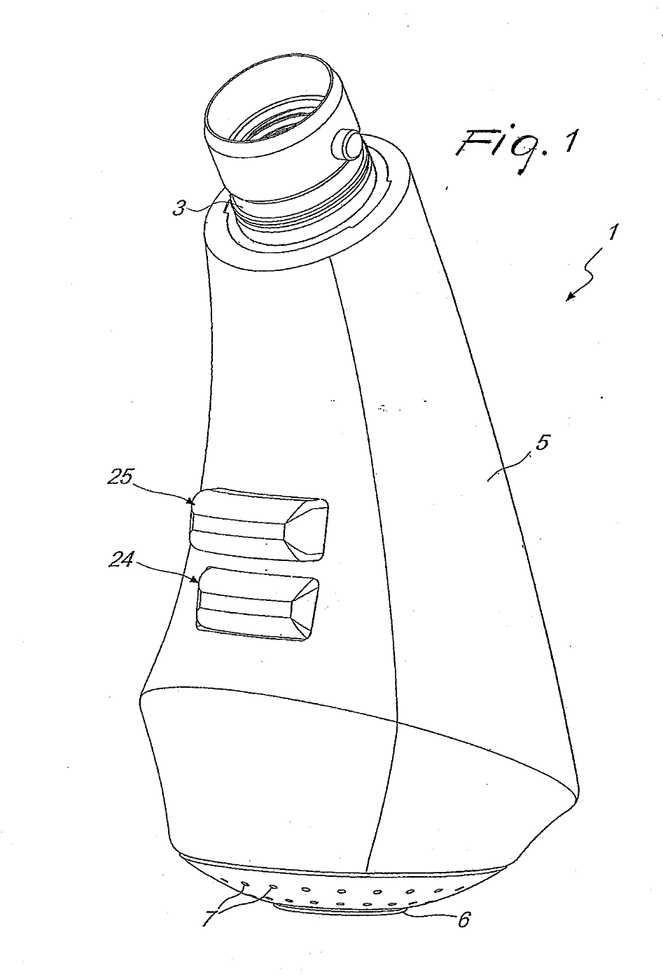

FIG. 2 shows the sink spray head of FIG. 1 where the casing or external shell has been removed;

FIG. 3 shows the sink spray head of FIG. 2 where the area of the diverting cut-off has been sectioned;

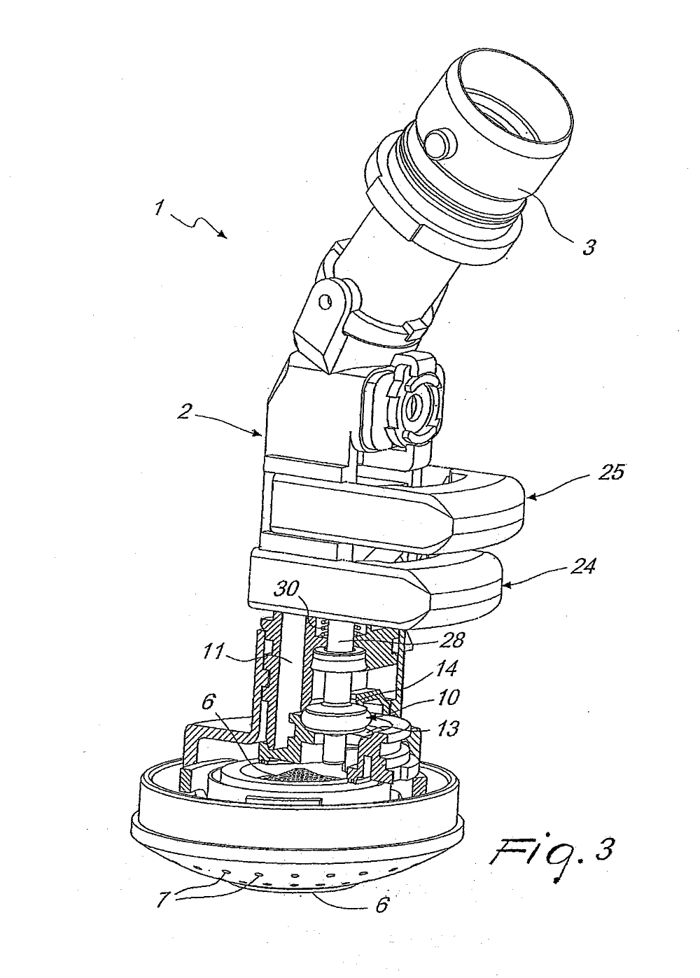

FIG. 4 shows a section view of the sink spray head positioned on the supply of the central jet and whose flow rate is closed;

FIG. 5 schematically shows a perspective, section view of the supply from the aerated central jet;

FIG. 6 schematically shows a perspective, section view of the spray head positioned for the central supply and whose flow rate is closed;

FIG. 7 schematically shows a perspective, section view of the spray head positioned for the indiscriminate peripheral supply; and

FIG. 8 shows a perspective, section view of the spray head positioned for the indiscriminate supply and whose flow rate is closed.

### DETAILED DESCRIPTION OF THE INVENTION

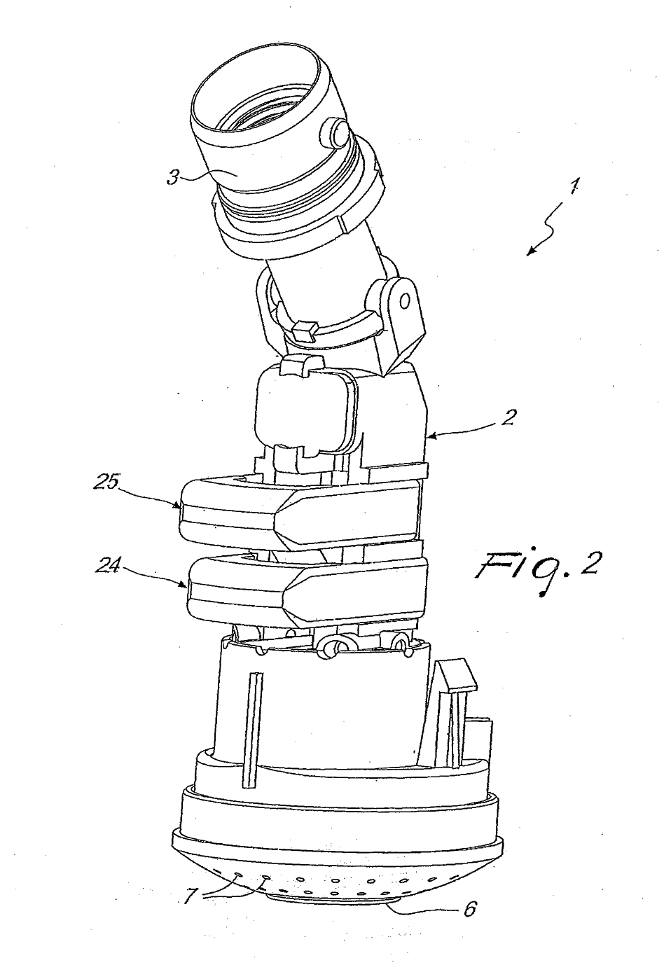

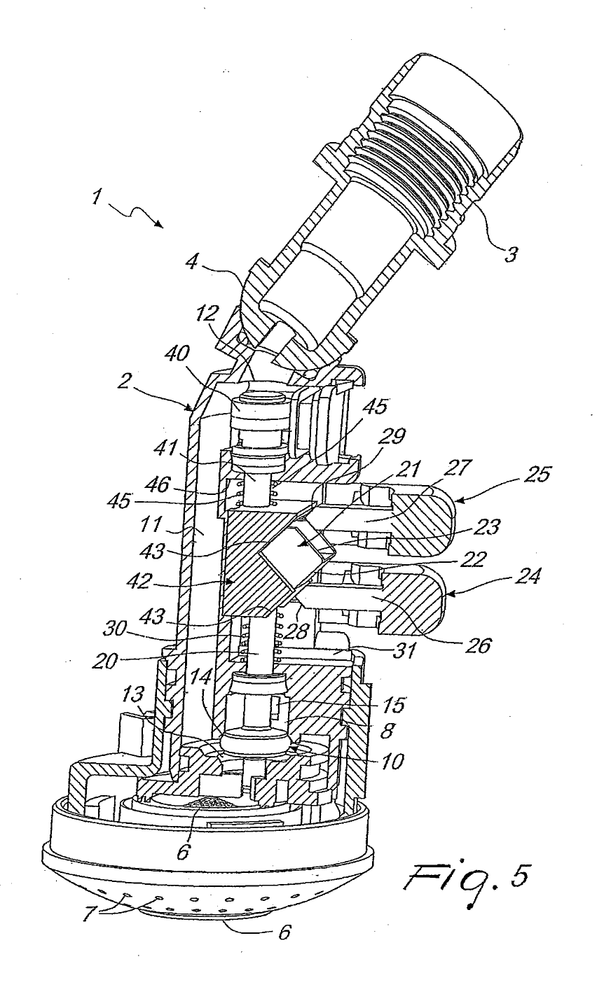

With reference to the cited figures, the sink spray head with supply jet variation and flow rate regulation, according to the invention, and being indicated with reference number 1, comprises a body 2 (FIG. 2) which is connected to a mouth 3 of connection to the water supply through a ball joint 4 (FIG. 5) which gives the possibility to obtain, with the same typology of mechanism, different conformations of the spray head, thanks to the possibility to modify the conformation of the covering external shell 5, by varying the angle between mouth 3 and body 2.

The body 2 defines two distinct water supply areas which are constituted by a central area 6 for the supply of an aerated central jet and by a peripheral area 7 for the supply of an indiscriminate jet.

The areas 6 and 7 are in communication with a distribution chamber 8 wherein a diverting cut-off 10, which will be described in detail hereafter, acts.

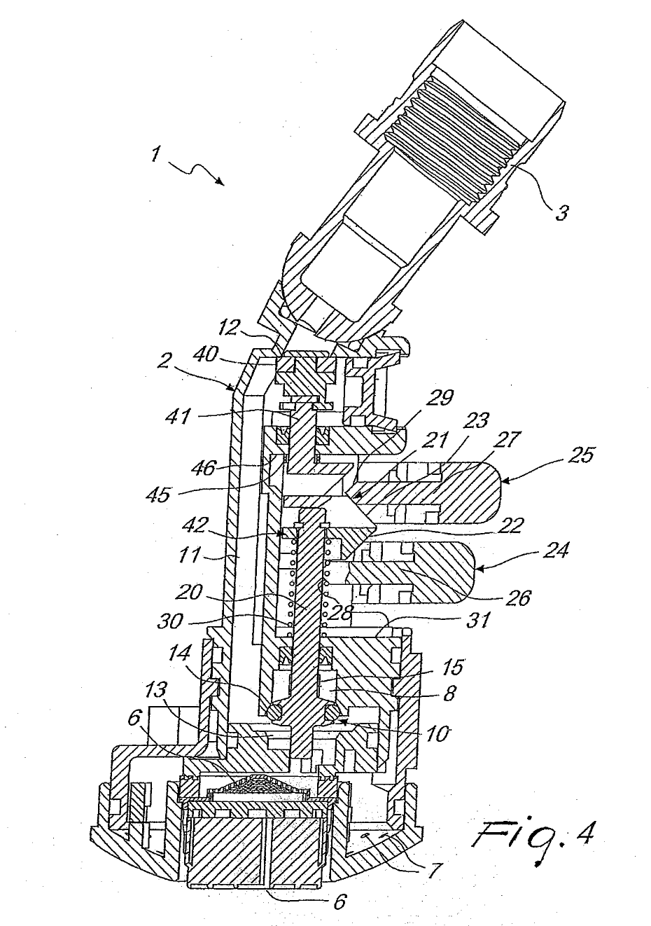

As illustrated in FIGS. 4-8, the chamber 8 is in communication with a water delivery duct 11 which is connected to the mouth 3 through a passage port 12.

The chamber 8 defines a lower port 13 which controls the communication with the central area 6 and an upper port 14 which controls the communication with a passage hole 15 for the connection to the peripheral area 7.

The diverting cut-off 10 is connected to a small shaft 20 which is operatively associated with a first slide 21 which defines a first and a second weathering 22 and 23 opposite to each other and suitable for interacting with a first and second selection key 24 and 25 which are accessible outside the shell 5 on the external surface of the spray head.

The keys 24 and 25 are equipped with a respective stem 26 and 27, each of which ends with a double weathering end 28 and 29 which has the function of interacting with the opposite weathering sections 22 and 23 of the first slide 21.

More in detail, the first key 24, when activated, acts on the first weathering 22 causing the translation upwards (as viewed in the drawings) of the cut-off 10 which abuts onto the second port 14 placing the chamber 8 in communication with the central jet.

By acting on the second key 25, it weathering end 29 engages with the second weathering 23 causing the translation downwards (as viewed in the drawings) of the cut-off 10, with consequent closure of the first port and opening of the second port with passage of the water through the chamber 8 towards the opening 15, which is in communication with the second area 7 or peripheral area which executes a supply with an indiscriminate jet.

First elastic means are then provided constituted by a first return spring 30 which acts between an abutment spigot 31 defined inside the body 2 and the first slide 21 so as to bring, under non activation conditions, the diverting cut-off 10 back in abutment onto the second port 14, putting the delivery 11 in communication with the central jet.

An important peculiarity of the invention is that the keys 24 and 25, besides executing the selection, are also able to operate the flow rate regulation, by acting on the flow rate regulation cut-off 40 which controls the port 12 and which is associated with a second small shaft 41 connected to a second slide 42 which is equipped with two inclined ramps 43 parallel and spaced from each other which can be engaged by the ends 28 and 29 of the keys 24 and 25 which execute an extra-stroke with respect to the stroke in engagement with the slide.

For completing the assembly, second elastic means are then provided constituted by a second return spring 45 which acts between the second slide 42 and an upper spigot 46 defined by the body 2.

As schematically shown in FIG. 5, the first key 24 is pressed and, acting on the first slide 21, maintains the diverting cut-off 10 in an elevated position, consequently obtaining the supply through the central area 6.

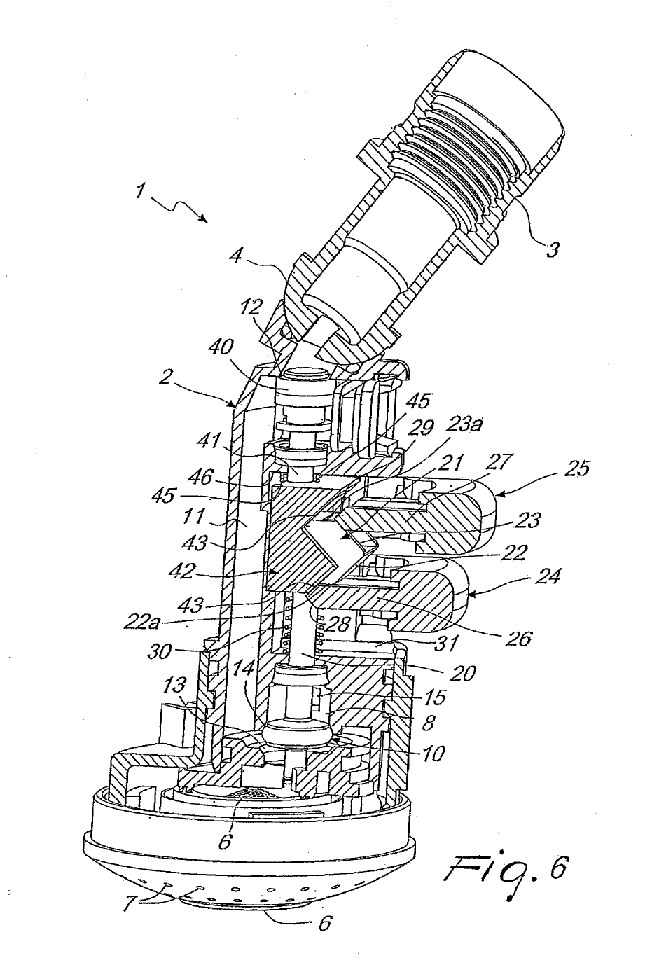

By further pressing the first key 24, as shown in FIG. 6, its double weathering end 28 engages with one of the ramps 43 of the second slide, causing the translation of the flow rate regulation cut-off 40 against the second spring 45, so that the cut-off closes the port 12 executing the blocking of the flow rate or, however, in case it is not completely pressed, a regulation of the flow rate.

It is to be noted that the stem 26 of the first key 24 is positioned, spigot-wise, on the lower edge 22a of the slide 21, therefore the slide 21, even when the flow rate is interrupted, by means of the key 24, can change its positioning.

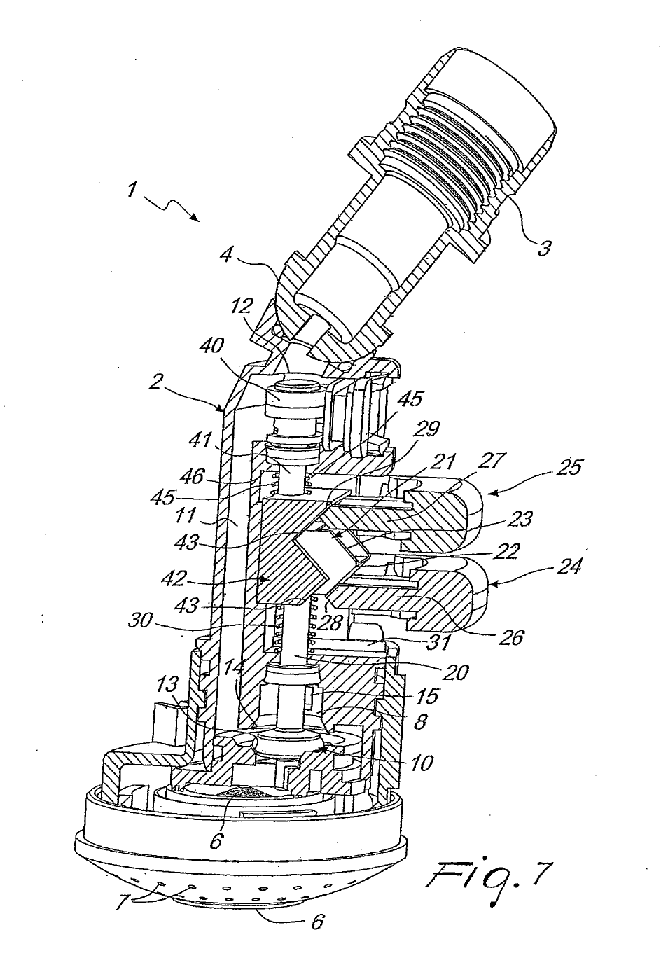

As shown in FIG. 7, the second key 25 is activated and, in this case, the first slide 21 is translated downwards with passage of the water flow rate towards the surface 7.

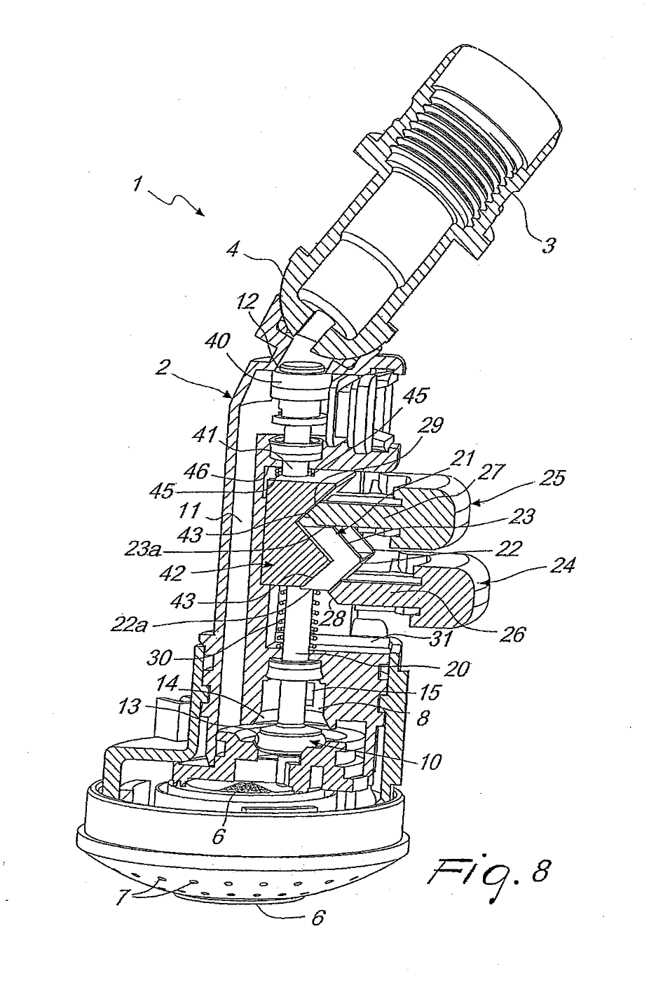

By further acting on the second key 25, as shown in FIG. 8, the translation of the second slide 42, which brings the cut-off to closure, is caused.

Also in this case it is to be noted that the first slide 21 maintains the position taken, since the stem 27 of the second key 25 is positioned, spigot-wise, with the upper wall 23a of the first slide, preventing it from modifying its positioning.

With the solution described it thus results that, even interrupting the flow, by acting on the keys 24 or 25 the positioning taken by the diverting cut-off 10 is not modified.

In case the flow is instead interrupted by acting on the tap, the first return spring 30 causes the translation of the diverting cut-off 10 upwards, making reference to the drawings, therefore the successive supply occurs, as typical, always in the central area.

As per what has been above shown, it is clear how the invention attains the proposed aims and in particular underlines the fact that a spray head is realised wherein only two activation keys are present giving the possibility to execute the variation of the supply jet, i.e., the deviation of the jet supply from the central area to the peripheral area, or vice versa, and offering the possibility, with a further stroke, to execute the flow rate regulation, since it is enough that the user further acts on the key which is, at the moment, pressed for obtaining the flow rate regulation until it is totally interrupted.

Another important aspect is that the spray head body is connected to the connection mouth 3 by means of a ball joint which allows a user to vary, at will, the relative positioning between body 2 and mouth, therefore it is possible, by maintaining the same mechanics, to vary, at will, the external conformation of the spray head.

The invention thus conceived can be subjected to several modifications and versions all within the inventive concept.

Moreover, all the details will have the possibility to be substituted by other technically equivalent elements.

In practice, the materials used, as well as the dimensions and the specific shapes, will be of any type according to the needs.

Advantageously, according to the spray head of the present invention, the flow rate regulation executed directly by the spray head does not imply a variation of the supply jet type.

The spray head, thanks to its peculiar realization features, is able to give the widest guarantees of reliability and safety of use,.

Moreover, the spray head can be easily realized starting from elements and materials being commonly available on sale and which, moreover, is competitive from a merely economic point of view.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A sink spray head with supply jet variation and flow rate regulation, comprising a body defining at least two distinct water supply areas in communication with a distribution chamber controlled by a diverting first cut-off manipulable by means of two distinct selection keys accessible outside the body, a second cut-off being also provided for the regulation of the water flow rate, wherein the selection keys are operatively engageable with the second cut-off.

2. A sink spray head with supply jet variation and flow rate regulation, comprising a body defining at least two distinct water supply areas in communication with a distribution chamber controlled by a diverting first cut-off manipulable by two distinct selection keys accessible outside the body, a water flow rate regulation second cut-off being also provided, wherein the second cut-off can be activated independently from one of the selection keys.

3. A sink spray head according to claim 1 or claim 2, wherein the spray head comprises a water delivery duct connected to the distribution chamber and defining a passage port controlled by the flow rate regulation second cut-off.

4. A sink spray head according to claim 1 or claim 2, wherein the distribution chamber defines a lower port controlling the communication with a central area and an upper port controlling the communication with a peripheral area of an indiscriminate jet.

5. A spray head according to claim 1 or claim 2, wherein the selection keys comprise a first and a second selection key equipped with a respective stem suitable for interacting with a first slide connected to the first cut-off.

6. A sink spray head according to claim 5, wherein the first slide defines a first and a second weathering opposite to each other and suitable for engaging respectively with the first selection key and the second selection key for transforming a translation of the respective selection key into a translation of a shaft of the first cut-off along a direction at least substantially perpendicular to the translation direction of the keys.

7. A sink spray head according to claim 6, wherein each stem of the keys ends with a double weathering end.

8. A sink spray head according to claim 5, wherein the spray head comprises a second slide flanked with respect to the first slide and operatively engageable with the regulation second cut-off, the stem of the respective selection keys being suitable for interacting with the second slide equipped with two inclined ramps substantially parallel to each other and both suitable for being engaged by the stem of one of the selection keys.

9. A sink spray head according to claim 8, wherein the selection keys can execute an extra-stroke with respect to the stroke necessary to execute the variation of the supply jet, the extra-stroke for defining the flow rate regulation through the engagement with the second slide.

10. A sink spray head according to claim 5, wherein the spray head comprises a first elastic means acting between an abutment spigot defined by the body and the first slide for bringing the diverting first cut-off back into abutment onto said upper port when a water flow determined by a tap placed upstream of the spray head is interrupted.

11. A sink spray head according to claim 8, wherein the spray head comprises a second elastic means acting between said second slide and an upper spigot defined by the body for bringing said regulation second cut-off back to the opening position at the end of the activation on the selection keys.

12. A sink spray head according to claim 9, wherein the stems of said selection keys when the extra-stroke is executed engage with a side portion of said first slide for keeping it in the position taken.

13. A sink spray head according to claim 1, wherein the spray head comprises a ball joint interposed between the body and a mouth of connection to a water supply for modifying the conformation of the external shell of the spray head.
